(19) United States
(12) Patent Application Publication
(10) Pub. No.: US 2016/0295182 A1
(43) Pub. Date: Oct. 6, 2016

(54) DLP MICRO PROJECTOR

(71) Applicant: IVIEW LIMITED, Hong Kong (CN)

(72) Inventors: Zhiqiang GAO, Hong Kong (CN); Yuan ZHAO, Hong Kong (CN); Steve YEUNG, Hong Kong (CN); Qingyun LIN, Hong Kong (CN)

(21) Appl. No.: 15/037,934

(22) PCT Filed: Nov. 7, 2014
(86) PCT No.: PCT/CN2014/090583

§ 371 Date: May 19, 2016

(30) Foreign Application Priority Data
May 15, 2014 (CN) 201420248249.X

(51) Int. Cl. H04N 9/31; G02B 26/08; G02B 17/08; G02B 17/02; G02B 27/30; G02B 3/00

(52) U.S. Cl. CPC H04N 9/3173; H04N 9/3108; H04N 9/3164; H04N 9/3158; G02B 27/30; G02B 3/0056; G02B 17/08; G02B 17/02; G02B 26/0833

(57) ABSTRACT

The invention provides a DLP micro projector including: a light supply device, including: a LED light source and a light collimation system, and a spectroscope group; a light path switching device, including a fly-eye lens or an optical wand; a lighting optical system, including: a freeform lens or a freeform reflector, and a right angle prism; a DMD light modulator being parallel to a right angle side of the right angle prism; and a projection lens group. The DLP micro projector has a simple and reasonable structure, employs a freeform optical component to replace the conventional planar mirror and relay lens to redirect and converge the beams, and meanwhile compensates the lighting source of the DMD light modulator, thereby simplifying the optical components and reducing the size and weight of the DLP micro projector. The projector features a compact structure, small size, low production cost, and high projection performance.

### FIELD OF THE INVENTION

The invention relates to the field of digital projection display, and more particularly to a DLP micro projector.

### BACKGROUND OF THE INVENTION

In recent years, with the development and application of handheld electronic devices, projection display system is increasingly miniature and highly qualified. With the maturity of LED light source and DLP technology, DLP projector are developed quickly, and become a popular projection and display mode.

In 1987, Digital Mirror Device (DMD) was invented by Texas Instruments (TI) company, where digital light processing technique was first introduced, which prompts the development of DLP micro projectors. Digital Mirror Device is a digital optical switch modulated by binary pulse width, and is the most complicated optical switch element. Thousands of micro square mirrors are fabricated on a hinge structure above the static random access memory to form the DMD. Each mirror can switch off the light of a pixel. The hinge structure allows each mirror to tilt between two states, +10 represents “open”, and −10 represents “close”. When the mirror is idle, it stays at zero position, which means “resting”.

To facilitate the extensive application and carrying of DLP micro projectors, the size and weight of the projection system should be greatly reduced. As shown in FIG. 1, alighting optical system of the DLP micro projector includes a planar mirror 101 and two relay lenses 102, 103 disposed in front and at the back of the planar mirror, which operate to shift and converge beam lights, respectively. The introduction of the planar mirror and the relay lenses complicates the DLP micro projector, and brings about troubles for further reducing the size and weight of the DLP micro projector.

The information disclosed in the background of the invention aims to facilitate the understanding of the general background of the invention, which should not be regarded directly or indirectly as admission or suggestion that the invention has been a well-known technology to one of ordinary skill in the art.

### SUMMARY OF THE INVENTION

One objective of the invention is to provide a DLP micro projector that has a simple and reasonable structure, employs a freeform optical component to replace the conventional planar mirror and relay lens to redirect and converge the beams, and meanwhile compensates the lighting source of the DMD light modulator, thereby simplifying the optical components and reducing the size and weight of the DLP micro projector. The projector features a compact structure, small size, low production cost, and high projection performance.

To achieve the above objective, the invention provides a DLP micro projector comprising: a light supply device, the light supply device comprising: a LED light source and a light collimation system, and a spectroscope group; a light path switching device, the light path switching device comprising a fly-eye lens or an optical wand; a lighting optical system, the lighting optical system comprising: a freeform lens or a freeform reflector, and a right angle prism; a DMD light modulator, the DMD light modulator being parallel to a right angle side of the right angle prism; and a projection lens group.

In a class of this embodiment, the LED light source comprises a blue LED light source, a green LED light source, and a red LED light source; a red light path of the red LED light source is parallel to a green light path of the green LED light source, and a blue light path of the LED blue light source is vertical to the red light path of the red LED light source and the green light path of the green LED light source.

In a class of this embodiment, the light collimation system comprises a first collimation lens group, a second collimation lens group, and a third collimation lens group, which are disposed at light paths of the blue LED light source, the green LED light source, and the red LED light source, respectively.

In a class of this embodiment, central optical axles of the first collimation lens group, the second collimation lens group, and the third collimation lens group are coincident with central optical axles of the blue LED light source, the green LED light source, and the red LED light source, respectively.

In a class of this embodiment, the spectroscope group comprises a first spectroscope and a second spectroscope which are parallel to each other; the first spectroscope reflects light beams from the green LED light source and allows light beams from the blue LED light source to transmit, and the second spectroscope reflects light beams from the red LED light source and allows the light beams from the blue LED light source and from the green LED light source to transmit, so as to transmit the lights from the three LED light sources along the horizontal direction in parallel to the light path switching device.

In a class of this embodiment, the LED light source comprises a bicolor LED light source and a monochromatic LED light source; the bicolor LED light source comprises a red LED chip and a blue LED chip; the monochromatic LED light source comprises a green LED chip, and a central optical axis thereof is coincident with that of the light path switching device.

In a class of this embodiment, the light collimation system comprises a fourth collimation lens group and a fifth collimation lens group; the fourth collimation lens group is disposed along a light direction of the bicolor LED light source, and a central optical axis thereof is coincident with a vertical optical axis at a center of a line connecting the red LED chip and the blue LED chip; the fifth collimation lens group is disposed along a light direction of the monochromatic LED light source, and a central optical axis thereof is coincident with an optical axis of the green LED chip.

In a class of this embodiment, the spectroscope group comprises a third spectroscope and a fourth spectroscope; the third spectroscope reflects light beams from the blue LED chip and allows light beams from the red LED chip and the green LED chip to transmit, and the fourth spectroscope reflects light beams from the red LED chip and allows the light beams from the blue LED chip and from the green LED chip to transmit, so as to transmit the lights from the three LED light sources along the horizontal direction in parallel to the light path switching device..

In a class of this embodiment, a freeform of the freeform lens or the freeform reflector is represented as follows:

$$Z = \frac{{cr}^{2}}{1 + \sqrt{1 - ( 1 + k ) {c}^{2} {r}^{2}}} + {A}_{1} X + {A}_{2} Y + {A}_{3} {X}^{2} + {A}_{4} XY + {A}_{5} {Y}^{2} + {A}_{6} {X}^{3} + {A}_{7} {X}^{2} Y + {A}_{8} {XY}^{2} + {A}_{9} {Y}^{3}$$

Z represents surface height, X and Y at each occurrence represent projection coordinate of the surface height on the optical axis, A1-A9 represent location parameter, c and k represent curvature parameter, and r=\sqrt{X²+Y²}.

Advantages of the invention are summarized as follows. The DLP micro projector has a simple and reasonable structure, employs a freeform optical component to replace the conventional planar mirror and relay lens to redirect and converge the beams, and meanwhile compensates the lighting source of the DMD light modulator, thereby simplifying the optical components and reducing the size and weight of the DLP micro projector. The projector features a compact structure, small size, low production cost, and high projection performance.

### BRIEF DESCRIPTION OF THE DRAWINGS

FIG. 1 is a schematic diagram of a DLP micro projector in the prior art;

FIG. 2 is a schematic diagram of a DLP micro projector in Example 1 of the invention;

FIG. 3 is a schematic diagram of a DLP micro projector in Example 2 of the invention;

FIG. 4 is a schematic diagram of a DLP micro projector in Example 3 of the invention; and

FIG. 5 is a schematic diagram of a DLP micro projector in Example 4 of the invention.

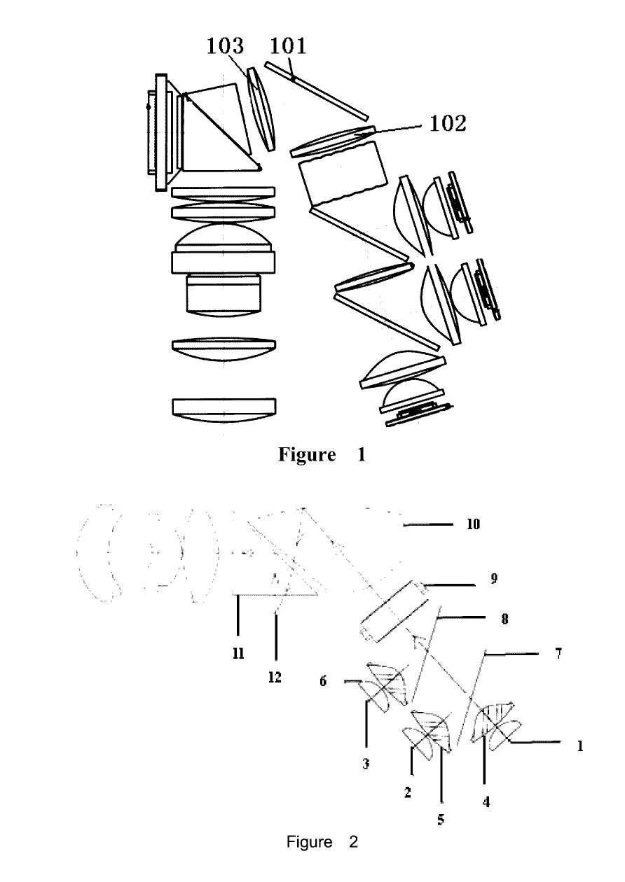

### DETAILED DESCRIPTION OF THE EMBODIMENTS

For clear understanding of the objectives, features and advantages of the invention, detailed description will be given below in conjunction with accompanying drawings and specific embodiments. It should be noted that the examples are only meant to explain the invention, and not to limit the scope of the invention.

Unless otherwise indicated, terms “comprise” or “comprising” in the specifications and claims of the invention should be considered as including stated elements or components, and not excluding other elements or components.

### EXAMPLE 1

As shown in FIG. 2, a DLP micro projector comprises along the light path: a light supply device, a light path switching device, a lighting optical system, a DLP light modulator 12, and a projection lens group.

The light supply device comprises: a LED light source and a light collimation system, and a spectroscope group. The LED light source comprises a blue LED light source 1, a green LED light source 2, and a red LED light source 3, the chips of which are packaged in three LEDs, respectively. The red light path of the red LED light source 3 is parallel to the green light path of the green LED light source 2, and the blue light path of the LED blue light source 1 is vertical to the red light path of the red LED light source 3 and the green light path of the green LED light source 2.

The light collimation system comprises a first collimation lens group 4, a second collimation lens group 5, and a third collimation lens group 6, which are disposed at light paths of the blue LED light source 1, the green LED light source 2, and the red LED light source 3, respectively, to receive and homogenize natural lights from the blue LED light source, the green LED light source, and the red LED light source. Preferably, the central optical axles of the first collimation lens group 4, the second collimation lens group 5, and the third collimation lens group 6 are coincident with central optical axles of the blue LED light source 1, the green LED light source 2, and the red LED light source 3, respectively.

The spectroscope group comprises a first spectroscope 7 and a second spectroscope 8 which are parallel to each other; the first spectroscope 7 reflects light beams from the green LED light source 2 and allows light beams from the blue LED light source 1 to transmit, and the second spectroscope 8 reflects light beams from the red LED light source 3 and allows the light beams from the blue LED light source 1 and from the green LED light source 2 to transmit, so that parallel lights from the blue, red, and green LED light sources are transmitted to the light path switching device.

The light path switching device comprises a fly-eye lens 9 or an optical wand.

The lighting optical system comprises: a freeform lens 10 and a right angle prism 11. The freeform lens 10 shapes the light beams having similar shapes from the fly-eye lens (or an optical wand) 9 and from the effective areas of the DMD light modulator 12. The light beams are fully reflected by the freeform lens 10 and enter the right angle prism 11, and then are incident to the DMD light modulator 12. The DMD light modulator 12 is parallel to one right angle side of the right angle prism 11. When the DMD light modulator 12 is in an open state, the projection beams reflected from the DMD light modulator 12 are incident to the hypotenuse of the right angle prism 11 and are totally reflected, and the reflected beams enter and lighten the projection lens group. When the DMD light modulator 12 is in a close state, the light beams have no way entering the projection lens group, thus producing a dark image. Through the modulation of the DMD light modulator, images are projected on the projection screen.

The freeform of the freeform lens is represented as follows:

$$Z = \frac{{cr}^{2}}{1 + \sqrt{1 - ( 1 + k ) {c}^{2} {r}^{2}}} + {A}_{1} X + {A}_{2} Y + {A}_{3} {X}^{2} + {A}_{4} XY + {A}_{5} {Y}^{2} + {A}_{6} {X}^{3} + {A}_{7} {X}^{2} Y + {A}_{8} {XY}^{2} + {A}_{9} {Y}^{3}$$

Z represents surface height, X and Y at each occurrence represent projection coordinate of the surface height on the optical axis, A1-A9 represent location parameter, c and k represent curvature parameter, and r=\sqrt{X²+Y²}.

### EXAMPLE 2

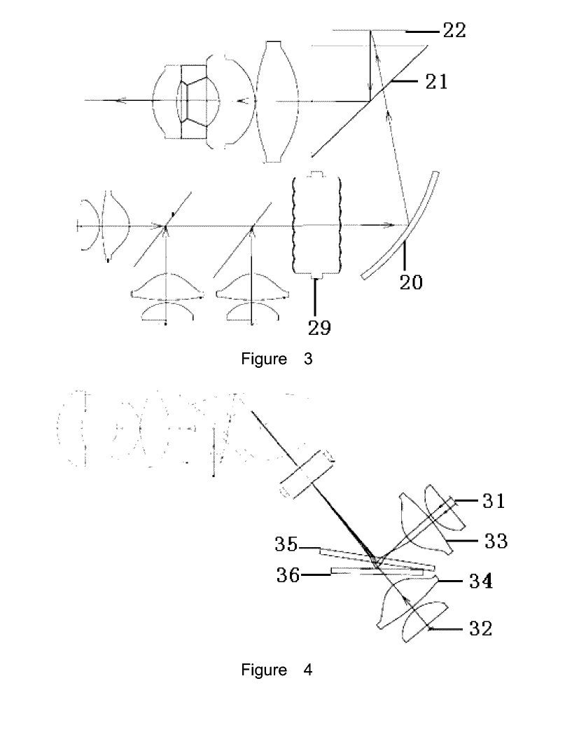

FIG. 3 is a schematic diagram of a DLP micro projector in this example 2. In this example, the freeform lens in Example 1 is replaced by a freeform reflector, while the light supply device is the same as that in Example 1.

The lighting optical system comprises: a freeform reflector 20 and a right angle prism 21. The freeform reflector 20 shapes the light beams having similar shapes from the fly-eye lens 29 and from the effective areas of the DMD light modulator 22. The light beams are fully reflected by the freeform reflector 20 and enter the right angle prism 21, and then are incident to the DMD light modulator 22. The DMD light modulator 22 is parallel to one right angle side of the right angle prism 21. When the DMD light modulator 22 is in an open state, the projection beams reflected from the DMD light modulator 22 are incident to the hypotenuse of the right angle prism 21 and are totally reflected, and the reflected beams enter and lighten the projection lens group. When the DMD light modulator 12 is in a close state, the light beams have no way entering the projection lens group, thus producing a dark image.

The freeform of the freeform reflector is represented as follows:

$$Z = \frac{{cr}^{2}}{1 + \sqrt{1 - ( 1 + k ) {c}^{2} {r}^{2}}} + {A}_{1} X + {A}_{2} Y + {A}_{3} {X}^{2} + {A}_{4} XY + {A}_{5} {Y}^{2} + {A}_{6} {X}^{3} + {A}_{7} {X}^{2} Y + {A}_{8} {XY}^{2} + {A}_{9} {Y}^{3}$$

Z represents surface height, X and Y at each occurrence represent projection coordinate of the surface height on the optical axis, A1-A9 represent location parameter, c and k represent curvature parameter, and r=\sqrt{X²÷Y²}.

### EXAMPLE 3

FIG. 4 is a schematic diagram of a DLP micro projector in this example 3. In this example, the light supply device is different from that in Example 1.

The light supply device comprises a bicolor LED light source 31 and a corresponding fourth collimation lens group 33 thereof, a monochromatic LED light source 32 and a corresponding fifth collimation lens group 34, and a spectroscope group. The bicolor LED light source 31 comprises a red LED chip and a blue LED chip; the monochromatic LED light source 32 comprises a green LED chip, and a central optical axis thereof is coincident with that of the light path switching device.

The fourth collimation lens group 33 is disposed along a light direction of the bicolor LED light source 31, and a central optical axis thereof is coincident with a vertical optical axis at a center of a line connecting the red LED chip and the blue LED chip, so as to receive and homogenize lights from the bicolor LED light source 31 to be approximate parallel lights; the fifth collimation lens group 34 is disposed along a light direction of the monochromatic LED light source 32, and a central optical axis thereof is coincident with an optical axis of the green LED chip, so as to receive and homogenize lights from the monochromatic LED light source 32 to be approximate parallel lights. The transmitted light from the fifth collimation lens group 34 is vertical to the transmitted light from the fourth collimation lens group 33.

The spectroscope group is disposed at the intersection of the transmitted lights of the fourth collimation lens group 33 and the fifth collimation lens group 34, the spectroscope group comprises a third spectroscope 35 and a fourth spectroscope 36; the third spectroscope 35 reflects light beams from the blue LED chip and allows light beams from the red LED chip and the green LED chip to transmit, and the fourth spectroscope 36 reflects light beams from the red LED chip and allows the light beams from the blue LED chip and from the green LED chip to transmit, so as to transmit the lights from the bicolor LED light source 31 and the monochromatic LED light source 32 in parallel to the light path switching device.

### EXAMPLE 4

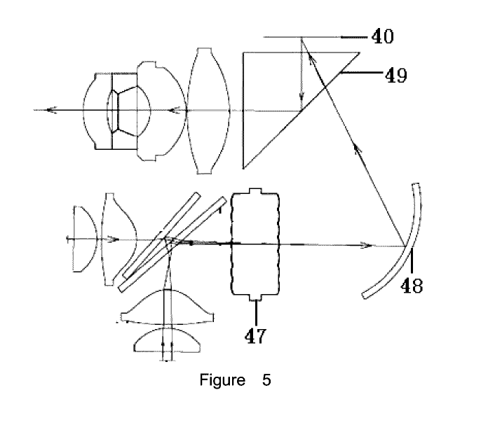

FIG. 5 is a schematic diagram of a DLP micro projector in this example 4. In this example, the lighting optical system is the same as that in Example 2, and the light supply device is the same as that in Example 3.

The lighting optical system comprises: a freeform reflector 48 and a right angle prism 49. The freeform reflector 48 shapes the light beams having similar shapes from the fly-eye lens 47 and from the effective areas of the DMD light modulator 40. The light beams are fully reflected by the freeform reflector 48 and enter the right angle prism 49, and then are incident to the DMD light modulator 40. The DMD light modulator 40 is parallel to one right angle side of the right angle prism 49. When the DMD light modulator is in an open state, the projection beams reflected from the DMD light modulator are incident to the hypotenuse of the right angle prism 49 and are totally reflected, and the reflected beams enter and lighten the projection lens group. When the DMD light modulator is in a close state, the light beams have no way entering the projection lens group, thus producing a dark image.

In summary, the DLP micro projector has a simple and reasonable structure, employs a freeform optical component to replace the conventional planar mirror and relay lens to redirect and converge the beams, and meanwhile compensates the lighting source of the DMD light modulator, thereby simplifying the optical components and reducing the size and weight of the DLP micro projector. The projector features a compact structure, small size, low production cost, and high projection performance.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A DLP micro projector, comprising:
a light supply device, the light supply device comprising: a LED light source and a light collimation system, and a spectroscope group;
a light path switching device, the light path switching device comprising a fly-eye lens or an optical wand;
a lighting optical system, the lighting optical system comprising: a freeform lens or a freeform reflector, and a right angle prism;
a DMD light modulator, the DMD light modulator being parallel to a right angle side of the right angle prism; and
a projection lens group.

2. The DLP micro projector of claim 1, wherein
the LED light source comprises a blue LED light source, a green LED light source, and a red LED light source; a red light path of the red LED light source is parallel to a green light path of the green LED light source, and a blue light path of the LED blue light source is vertical to the red light path of the red LED light source and the green light path of the green LED light source.

3. The DLP micro projector of claim 2, wherein
the light collimation system comprises a first collimation lens group, a second collimation lens group, and a third collimation lens group, which are disposed at light paths of the blue LED light source, the green LED light source, and the red LED light source, respectively.

4. The DLP micro projector of claim 3, wherein
central optical axles of the first collimation lens group, the second collimation lens group, and the third collimation lens group are coincident with central optical axles of the blue LED light source, the green LED light source, and the red LED light source, respectively.

5. The DLP micro projector of claim 4, wherein
the spectroscope group comprises a first spectroscope and a second spectroscope which are parallel to each other; the first spectroscope reflects light beams from the green LED light source and allows light beams from the blue LED light source to transmit, and the second spectroscope reflects light beams from the red LED light source and allows the light beams from the blue LED light source and from the green LED light source to transmit.

6. The DLP micro projector of claim 1, wherein
the LED light source comprises a bicolor LED light source and a monochromatic LED light source; the bicolor LED light source comprises a red LED chip and a blue LED chip; the monochromatic LED light source comprises a green LED chip, and a central optical axis thereof is coincident with that of the light path switching device.

7. The DLP micro projector of claim 6, wherein
the light collimation system comprises a fourth collimation lens group and a fifth collimation lens group; the fourth collimation lens group is disposed along a light direction of the bicolor LED light source, and a central optical axis thereof is coincident with a vertical optical axis at a center of a line connecting the red LED chip and the blue LED chip; the fifth collimation lens group is disposed along a light direction of the monochromatic LED light source, and a central optical axis thereof is coincident with an optical axis of the green LED chip.

8. The DLP micro projector of claim 6, wherein
the spectroscope group comprises a third spectroscope and a fourth spectroscope; the third spectroscope reflects light beams from the blue LED chip and allows light beams from the red LED chip and the green LED chip to transmit, and the fourth spectroscope reflects light beams from the red LED chip and allows the light beams from the blue LED chip and from the green LED chip to transmit.

9. The DLP micro projector of claim 1, wherein
a freeform of the freeform lens or the freeform reflector is represented as follows:
$$Z = \frac{{cr}^{2}}{1 + \sqrt{1 - ( 1 + k ) {c}^{2} {r}^{2}}} + {A}_{1} X + {A}_{2} Y + {A}_{3} {X}^{2} + {A}_{4} XY + {A}_{5} {Y}^{2} + {A}_{6} {X}^{3} + {A}_{7} {X}^{2} Y + {A}_{8} {XY}^{2} + {A}_{9} {Y}^{3}$$
Z represents surface height, X and Y at each occurrence represent projection coordinate of the surface height on the optical axis, A1-A9 represent location parameter, c and k represent curvature parameter, and r=\sqrt{X²+Y²}.
